(19) United States
(12) Patent Application Publication
(10) Pub. No.: US 2014/0335312 A1
(43) Pub. Date: Nov. 13, 2014

(54) SUBSTRATE FILM FOR MANUFACTURING TRANSPARENT ELECTRODE FILM

(71) Applicants: Kwang Suck SUH, Gyeonggi-do (KR); INSCON TECH CO., LTD., Gyeonggi-do (KR); SOLOE TECH CO., LTD., Gyeonggi-do (KR)

(72) Inventors: Kwang Suck Suh, Gyeonggi-do (KR); Tae Young Kim, Seoul (KR); Jong Eun Kim, Seoul (KR)

(21) Appl. No.: 14/362,124

(22) PCT Filed: Nov. 30, 2012
(86) PCT No.: PCT/KR2012/010329

§ 371 Date: Jun. 1, 2014

(30) Foreign Application Priority Data
Dec. 2, 2011 (KR) 10-2011-0128635

(51) Int. Cl. C09D 133/14; H01B 5/14; H01B 13/00; C09D 133/08

(52) U.S. Cl. CPC C09D 133/14; C09D 133/08; H01B 5/14; H01B 13/003; H01B 13/0036
USPC 428/143; 524/561; 524/555; 524/558; 428/483; 427/508

(57) ABSTRACT

A transparent electrode film is manufactured by applying a transparent electrode material such as a conductive polymer, carbon nanotubes, graphene or metallic nanowires on the surface of a transparent substrate such as polyester, etc., wherein, in order to reduce changes in the surface resistance of the transparent electrode film during edge testing, photocurable resin layers are formed on both surfaces of the substrate film, and a transparent electrode layer is formed on the surface of either of the resin layers. This technique involves adjusting the degree of photocuring of the photocurable layers formed on both surfaces of the substrate film such that the degree of curing of the photocurable layer on one surface is at least 85%, and the degree of curing of the photocurable resin layer on the other surface falls in the range of 45 to 85% and then the transparent electrode layer is formed thereon.

### TECHNICAL FIELD

The present invention relates to a substrate film for use in manufacturing a transparent electrode film for a touch screen panel. More particularly, the present invention relates to a substrate film for a transparent electrode film, wherein a transparent electrode layer is formed on the surface of the substrate film using a transparent electrode composition comprising a conductive polymer or metallic nanowires.

### BACKGROUND ART

Recently, touch screen panels for smart phones, tablet PCs, etc. which may operate upon touch by fingers are mainly available. Because of use convenience, such panels are being applied to small electronic devices such as smart phones, and also to large display devices such as monitors, TVs, etc.

The core part of these touch screen panels is a transparent electrode layer or a transparent electrode film which may recognize touch by fingers or other tools. The transparent electrode film is manufactured by sputtering indium tin oxide (ITO) having high electrical conductivity to a thickness of at least tens of nm on the surface of a transparent substrate film such as polyester. The ITO film, having high electrical conductivity and high light transmittance, is being utilized as a transparent electrode film for almost all of the currently useful touch screen panels.

As for the ITO film, however, because the metal oxide having mechanically strong brittleness is formed to be thin on the surface of a flexible polymer substrate material, the surface ITO layer may crack upon thermal impact and thus cannot function as the electrode layer. Particularly when applying high heat and humidity as in aging testing which is performed while applying high humidity at a temperature equal to or higher than the glass transition temperature of a substrate film (e.g. when the substrate film is PET, aging testing is performed by allowing it to stand under conditions of 85° C. and 85% relative humidity for 120 hr; 85° C./85% RH/120 h test), the surface metal oxide layer may be mechanically damaged due to a difference in thermal expansion or thermal shrinkage between the substrate film and the ITO layer, undesirably incurring cracking. Furthermore, because the electrode layer is formed of the metal oxide having high brittleness, mechanical damage to the surface metal oxide layer may occur when force is applied to input letters thereon, undesirably causing problems in which the input letters are not further recognized.

### DISCLOSURE

### Technical Problem

Accordingly, the present invention has been made keeping in mind the above problems encountered in the related art, and an object of the present invention is to provide substrate film treatment and a transparent electrode film manufactured thereby, wherein when a transparent electrode film manufactured by forming a transparent electrode material on the surface of a substrate film is subjected to aging under conditions of high temperature and relative humidity, the substrate film treatment may prevent surface resistance from changing by 10% or more compared to initial values and a haze from remarkably increasing.

Another object of the present invention is to provide a method of treating a substrate film and a substrate film for a transparent electrode film manufactured thereby, wherein, in a transparent electrode film manufactured by applying a composition containing a conductive polymer, carbon nanotubes, graphene or metallic nanowires as an effective component on the surface of a substrate film, the method enables changes in surface resistance of the transparent electrode layer to be less than 10% compared to initial values even after various aging tests, and also, a haze to be less than a maximum of 3% or an increase in the haze after aging to be adjusted so as not to be equal to or higher than a maximum of 2%.

The objects of the present invention are not limited to the foregoing, and the other objects which are not mentioned herein will be able to be clearly understood to those skilled in the art from the following description.

### Technical Solution

In order to overcome the above problems, the present invention adopts a technique for forming a semi-cured layer on a substrate film, a technique for forming a transparent electrode layer on the semi-cured layer, and a transparent electrode layer using a conductive material such as a conductive polymer, carbon nanotubes, graphene or metallic nanowires such as silver, metal grids, etc. to facilitate the formation of the transparent electrode layer on the semi-cured layer.

Because a conductive polymer represented by polyethylenedioxythiophene (PEDOT) is an organic compound, when it is applied on the surface of a substrate film using an appropriate process, it advantageously prevents the electrode layer from cracking as in the metal oxide layer even under thermal impact. Also, metallic nanowires such as silver are advantageous in that, when the electrode layer is formed from a mixture of the nanowires and a binder or by directly applying the nanowires on the surface of a substrate film, the electrode layer comprises the interconnected nanowires, not the continuous single layer like metal oxide, and thus no cracking of the electrode layer takes place under thermal impact or upon thermal impact testing under heat and humidity.

However, when the transparent electrode film manufactured by forming the electrode layer using a composition containing a conductive polymer, carbon nanotubes, graphene or metallic nanowires as an effective component is subjected to various aging tests, for example, 85° C./85% RH/120 hr (RH; relative humidity), 60° C./90% RH/120 hr or accelerated life tests, there may occur problems in which changes in the surface resistance of the transparent electrode layer formed on the surface of the substrate are 10% or more compared to the initial values, or in which the haze may drastically increase. Particularly in the case where polyester is used for the substrate film, the 85° C./85% RH/120 hr aging testing suffers from severe changes in the surface resistance because 85° C. is higher than the glass transition temperature of the polyester film.

The present inventors have noticed that, due to aging at high temperature, the dimension of the substrate film may change or the surface blooming-out of an oligomer in the material may occur to thus damage the surface electrode layer and thereby the surface resistance of the electrode layer also changes, and thus have used methods for preventing such changes.

In order to prevent generation of problems associated with changes in the dimension of the substrate film and blooming-out of the oligomer during aging at high temperature, the present invention adopts a method of forming a photocurable resin layer on the surface of a substrate material. Specifically, the present invention provides a substrate film having a photocurable coating layer having a degree of curing of 45˜85% formed on one surface thereof so as to manufacture a transparent electrode film having a transparent substrate film and an electrode layer, and also provides a transparent electrode film configured such that the electrode layer is formed on the photocurable coating layer.

The thickness of the photocurable coating layer (resin layer) formed on the surface is regarded as effective so long as it is set to the extent of forming a photocurable resin layer, and thus particular limitations are not imposed thereon. As such, when the photocurable resin layer is fully cured, its tissue becomes very dense, and thus upon forming a material for another layer thereon, adhesion between two layers may significantly decrease, making it difficult to obtain desired adhesion. To solve such problems, the present invention involves a method of adjusting the degree of photocuring of the photocurable resin layer on the surface formed with the electrode material while forming photocurable resin layers are formed on both surfaces of the substrate material or the film.

The present invention provides a substrate film for use in manufacturing a transparent electrode film, comprising, when the substrate material is a film, a transparent substrate film including an electrode layer; a photocurable resin layer (hereinafter, referred to as a fully-cured layer) having a degree of curing of 85% or more on one surface of the substrate film; and a photocurable resin layer (hereinafter, referred to as a semi-cured layer) having a degree of curing of 45˜85% on the other surface thereof.

When forming, on the surface of the semi-cured layer of the above film, a transparent electrode layer containing a conductive polymer as an effective component or an electrode layer containing carbon nanotubes, graphene and metallic nanowires as an effective component, a highly reliable transparent electrode film can result, in which changes in the surface resistance are less than 10% compared to initial values even after various aging tests including 85° C./85% RH/120 hr, 60° C./90% RH/120 hr or accelerated life tests, and also a haze after aging is less than a maximum of 3% or changes in the haze after aging are less than a maximum of 2%.

The foregoing is described with reference to FIG. 1. As illustrated in FIG. 1, a substrate film for a transparent electrode film is configured such that a photocurable resin layer (a fully-cured layer) 20 having a degree of curing of 85% or more is formed on one surface of the substrate film 10, and a photocurable resin layer (a semi-cured layer) 30 having a degree of curing of 45˜85% is formed on the other surface thereof. Further, a transparent electrode layer 40 containing a desired material as an effective component is formed on the surface of the semi-cured resin layer.

The present invention provides a method of manufacturing a substrate film for forming a transparent electrode layer of a transparent electrode film, comprising forming a photocurable layer on one surface of the substrate film.

As such, the photocurable layer is formed by being cured to a degree of photocuring of 45˜85% so as to enhance adhesion to the transparent electrode layer formed thereon.

### Advantageous Effects

According to the present invention, when manufacturing a transparent electrode film by applying a composition containing a conductive polymer, carbon nanotubes, graphene or metal nanowries as an effective component on a substrate film prepared by the technique of the invention and then performing drying or curing, a very reliable transparent electrode film can result, in which changes in the surface resistance are less than 10% compared to initial values even after various aging tests for a long period of time under high temperature and high humidity, such as 85° C./85% RH/120 hr, 60° C./90% RH/120 hr or accelerated life tests, and also a haze after aging is less than 3% or an increase in the haze after aging is less than a maximum of 2%.

### DESCRIPTION OF DRAWING

FIG. 1 illustrates a layer configuration of a transparent electrode film according to the present invention.

### BEST MODE

The present invention addresses a substrate film for use in manufacturing a transparent electrode film comprising a transparent electrode layer containing a conductive polymer, carbon nanotubes, graphene or metallic nanowires as an effective component, wherein even after various aging tests, especially aging for 120 hr under conditions of 85° C./85% RH, changes in the surface resistance of the electrode layer are less than 10% compared to initial values and a haze is less than a maximum of 3% or an increase in the haze after aging is less than a maximum of 2%.

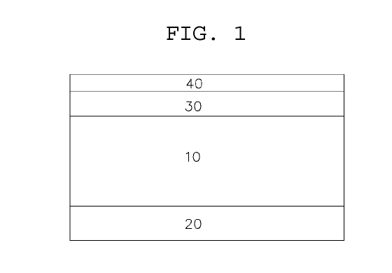

Below is a detailed description of a substrate film for use in manufacturing a transparent electrode film according to a preferred embodiment of the present invention, with reference to FIG. 1.

FIG. 1 illustrates a highly reliable substrate film configured such that a fully-cured photocurable layer 20 is formed on one surface of a substrate layer 10 made of a transparent polymer, and a semi-cured photocurable layer 30 is formed on the other surface thereof.

When an electrode layer 40 containing a conductive polymer or metallic nanowires as an effective component is formed on the semi-cured photocurable layer 30 of the substrate film, the resulting transparent electrode film may satisfy the following: changes in the surface resistance after aging are less than 10% compared to initial values and a haze is less than a maximum of 3% or an increase in the haze after aging is less than a maximum of 2%.

As for the substrate layer 10 of the transparent electrode film, any polymer may be used so long as it is transparent, and the use of a polyester film or a polycarbonate film is preferable.

As for the photocurable coating layer useful for the photocurable layers 20, 30 according to the present invention, any resin may be used without limitation so long as it is a typical photocurable resin. Generally, a photocurable resin including a monomer, an oligomer, etc., or a photocurable resin having a functional group or a plurality of functional groups may be used.

The photocurable layer 20 is a fully-cured photocurable layer having a degree of curing of 85% or more, and may be omitted as necessary.

The photocurable layer 30 is a photocurable resin layer having a degree of curing adjusted in the range of 45˜85%, namely, a semi-cured layer 30, having the same composition as in the fully-cured photocurable layer 20 or having different components as necessary. As such, the degree of curing may be controlled by adjusting the light dose of the formed photocurable resin layer.

The reason why a semi-cured photocurable layer or a semi-curing process is used is to utilize the property in which the surface of the photocurable resin layer remains tacky when the photocurable resin layer is semi-cured. Such tackiness functions to enhance adhesion to the electrode layer formed thereon. Thus, if curing is implemented to the extent that such tackiness disappears, namely to the degree of curing of 85% or more, surface tackiness of the resulting photocurable layer disappears and thus adhesion to the electrode layer formed thereon may decrease, which is undesirable. In contrast, if the degree of curing is less than 45%, adhesion to the electrode layer formed thereon may become good, but tackiness may remarkably increase and thus attachment to the counter surface when winding the film on a roll may occur or the semi-cured layer is too soft and thus work problems upon forming the electrode layer thereon may take place.

The semi-cured layer may vary depending on the component system formed thereon. For example, when an organic conductive material dispersed in an organic solvent is formed, a material for the photocurable layer may include a typical organic solvent-based photocurable resin composition. However, when forming a material for the electrode layer dispersed in an aqueous solvent, the photocurable resin composition may be mixed with a photocurable resin having a polar group. For example, in the case where the electrode layer 40 containing a conductive polymer, carbon nanotubes or metallic nanowires dispersed in the aqueous solvent, as an effective component, is formed on the semi-cured layer, the semi-curable resin may be mixed with a photocurable resin having an oxide group, for example, an acrylate having a methylene oxide group, an acrylate having an ethylene oxide group or an acrylate having the other polar group, advantageously forming the electrode layer having higher adhesion.

In the case where the acrylate having a polar group is mixed, it is an acrylate compound comprising an oxide compound containing alkyl, allyl or phenyl as a structure having one or more carbon atoms, and the amount thereof should be 5˜80 parts by weight based on 100 parts by weight of the acrylate resin. If the amount of the acrylate having a polar group is less than 5 parts by weight, it is too low and thus adhesion between the semi-cured layer and the conductive polymer layer thereon may become undesirably poor. In contrast, if the amount thereof is greater than 80 parts by weight, coating properties of the semi-cured layer may become undesirably too poor.

In the drawing, the electrode layer 40 is a transparent electrode layer. In the case of using a composition containing a conductive polymer, carbon nanotubes, graphene or metallic nanowires as an effective component, the composition adapted for each material is made and then properly applied on the surface, dried, or cured as necessary, thus forming the electrode layer. Even when different kinds of transparent electrode materials, other than the conductive polymer, carobn nanotubes, graphene or metallic nanowires, are used, the same effects may be obtained. Thus, the formation of the electrode layer, specifically, the kind of electrode material, the components of the composition and the preparation method thereof, the coating thickness, the coating method, etc., may not be particularly limited.

In the case where fine irregularities are intended to form on the surface where the conductive layer (electrode layer) is formed, the conductive layer may be formed by adding fine particles to the electrode layer material, or the semi-cured layer may be formed by adding fine particles to the semi-cured layer according to the present invention. As such, because the fine particles are used to impart fine irregularities to the surface, the kind thereof is not limited so long as it may impart fine surface irregularities. Especially, spherical particles having an aspect ratio of 1.0 or wire-shaped particles having a high aspect ratio may be used. The particles may include inorganic particles such as silica, alumina, zirconia, titanium oxide, calcium oxide, magnesium oxide, antimony oxide, boron oxide, tin oxide, tungsten oxide, zinc oxide, etc., or organic beads such as styrene, acryl, etc., and preferably have a particle size of 0.01˜10 μm.

Because the added particles should not decrease the light transmittance of a final transparent electrode film, the amount thereof should be equal to or less than 20 parts by weight based on 100 parts by weight of the total solid content. This amount range may be adjusted depending on the particle size. In the case of nanoparticles, they may be used in a large amount. However, when particles having a large particle size are used, the amount of such particles should be limited due to a decrease in light transmittance and an increase in haze. Preferably, the amount of the particles is set to 0.1˜10 parts by weight. If the amount of the particles is less than 0.1 parts by weight, the effect of enhancement of surface irregularities may become insignificant due to the very low amount of the particles. In contrast, if the amount thereof exceeds 10 parts by weight or 20 parts by weight, light transmittance may decrease or the haze may drastically increase due to the very high amount of the particles.

In the present invention, as for the substrate film represented by the substrate layer 10, any polymer film may be applied without limitation so long as it is usable as a substrate film for a touch screen panel. For example, a film comprising any one of ester, carbonate, styrene, amide, imide, cyclic olefin, sulfone, ether functional groups, etc., a film composed of a polymer resulting from copolymerization of one or more functional groups, a film comprising a polymer blend having one or more functional groups, or a multilayer film resulting from laminating polymer films having different functional groups, may be used without limitation so long as it is usable for the fabrication of a transparent electrode film.

The configuration of the transparent electrode film of FIG. 1 is a preferred embodiment of the present invention, and may be modified according to another embodiment. For instance, a fully-cured photocurable coating layer may be omitted. According to another embodiment, an antistatic coating layer may be formed with a conductive polymer coating layer on the fully-cured photocurable coating layer 20 of FIG. 1. This antistatic coating layer may be a typical coating layer.

### MODE FOR INVENTION

A better understanding of the present invention may be obtained through the following comparative examples and examples. However, the scope of the present invention is not limited to the examples or the polyester films used in the comparative examples and examples.

### COMPARATIVE EXAMPLE 1

A coating composition containing PEDOT as an effective component was applied on one surface of a commercially available 125 μm thick polyester film, and then dried, thus forming a conductive polymer electrode layer having a coating thickness of 120 nm, from which a transparent electrode film was then manufactured, and a touch cell was fabricated using such a film. When the touch cell was manufactured using the same film, the X-axis terminal resistance was 290 ohm and the Y-axis terminal resistance was 596 ohm. The reason why the Y-axis terminal resistance was higher is that a UV irradiation process was performed on the lower plate upon fabrication of the touch cell. Also, the haze was 1.2%.

The coating solution for an electrode layer, containing PEDOT used in this Comparative Example as the effective component, was prepared by mixing 34 g of a polythiophene conductive polymer solution, 60 g of ethylalcohol, 2 g of ethyleneglycol, 2 g of N-methyl-2-pyrrolidinone, 1.5 g of water-soluble urethane (based on 100% of solid content), and 0.5 g of a silicone-based additive.

This touch cell was placed in a thermohydrostat chamber of 85° C./85% RH, aged for 120 hr, taken out of the chamber, allowed to stand for about 8 hr, and dried, thus manufacturing a module for evaluation of aging properties.

The aging sample module thus treated had an X-axis terminal resistance of 435 ohm, and a Y-axis terminal resistance of 572 ohm, and the changes relative to the initial surface resistance values were about 50% in the upper plate and −4% in the lower plate, and the haze was measured to be about 4.0%.

### COMPARTIVE EXAMPLE 2

Comparative Example 2 was the same as Comparative Example 1, with the exception that a middle layer made of a thermosetting resin was formed on one surface of a 188 μm thick polyester film and an electrode layer was then formed thereon using a composition containing PEDOT as an effective component. As such, the X-axis terminal resistance was 266 ohm, and the Y-axis terminal resistance was 573 ohm. The haze of this sample was 1.18%.

The thermosetting composition for forming the middle layer of this Comparative Example was prepared by mixing 10 g of a urethane-based binder, 0.3 g of a curing agent, and 2 g of zirconium oxide (50 nm diameter, 10% isopropylalcohol dispersion) with 30 g of an isopropylalcohol solvent, applied on the surface of the polyester film, and then dried and cured, so that the resulting layer had a dry thickness of 5 μm.

The manufactured touch cell was aged under conditions of 85° C./85% RH for 120 hr, and a change in the X-axis terminal resistance was about 15%, and a change in the Y-axis terminal resistance was −3.4%. In particular, the haze of this sample remarkably increased to about 7% after aging.

### COMPARATIVE EXAMPLE 3

This Comparative Example was the same as Comparative Example 1, with the exception that a photocurable resin layer was formed on one surface of a 188 μm thick polyester film and then an electrode layer containing PEDOT as an effective component was directly formed without the photocurable layer on the other surface thereof. The X-axis terminal resistance of the sample was 275 ohm, and the Y-axis terminal resistance was 560 ohm.

After the same aging test, changes in the module were 40% in the upper plate and −10% in the lower plate. The haze was measured to be 3.92%.

### EXAMPLE 1

A semi-cured layer having a degree of curing adjusted to 60% through control of light dose was formed on one surface of a 188 μm thick polyester film.

As such, the photocurable resin composition used was prepared by mixing 10 g of a trifunctional acrylate monomer, 10 g of a trifunctional aliphatic acrylate oligomer, 10 g of a hexafunctional acrylate oligomer and 2 g of a 265 nm initiator with 68 g of ethylacetate. The photocurable composition was dried to a coating thickness of 5 μm, and the UV dose applied upon forming the curing layer was 600 mJ/cm².

The subsequent procedures were performed in the same manner as in Comparative Example 1, with the exception that the PEDOT composition of Comparative Example 1 was applied on the surface of the semi-cured layer and then dried to form an electrode layer.

The manufactured touch cell had an X-axis terminal resistance of 276 ohm and a Y-axis terminal resistance of 575 ohm.

The electrode layer of the manufactured touch module had an adhesion of 5B according to ASTM D3359, which is evaluated to be good, and also changes in the terminal resistance after aging testing were measured to be 8.6% in the upper plate and −5.2% in the lower plate. The sample had a haze of 1.95%.

### EXAMPLE 2

A fully-cured photocurable layer was formed on one surface of a 188 μm thick polyester film, and the same resin was applied on the other surface thereof, and thus a semi-cured layer having a degree of curing of 60% by adjusting the light dose was formed.

The photocurable resin composition used was prepared by mixing 10 g of a trifunctional acrylate monomer, 10 g of a trifunctional aliphatic acrylate oligomer, 10 g of a hexafunctional urethane acrylate oligomer and 2 g of a 265 nm initiator with 68 g of ethylacetate. The photocurable composition was dried to a coating thickness of 5 μm, and the UV dose applied upon forming the fully-cured layer was 600 mJ/cm².

The subsequent procedures were performed in the same manner as in Comparative Example 1, with the exception that the PEDOT composition of Comparative Example 1 was applied on the surface of the semi-cured layer and dried to form an electrode layer, and the fully-cured layer was formed.

The manufactured touch cell had an X-axis terminal resistance of 275 ohm and a Y-axis terminal resistance of 570 ohm.

The electrode layer of the manufactured touch module had an adhesion of 5B according to ASTM D3359, which is evaluated to be good, and also changes in the terminal resistance after aging testing were measured to be 8.5% in the upper plate and −5% in the lower plate. The sample had a haze of 1.95%.

### EXAMPLE 3

Example 3 was the same as Example 2, with the exception that the degree of curing of the semi-cured layer was 75%.

The manufactured touch cell had an X-axis terminal resistance of 265 ohm and a Y-axis terminal resistance of 587 ohm.

The electrode layer of the manufactured touch module had an adhesion of 5B according to ASTM D3359, which is evaluated to be good, and also changes in the terminal resistance after aging testing were measured to be 6.7% in the upper plate and −6.5% in the lower plate, and the haze was measured to be 1.96%.

### COMPARATIVE EXAMPLE 4

Comparative Example 4 was the same as Example 1, with the exception that the degree of curing of the semi-cured layer was adjusted to 35%.

When forming an electrode layer containing PEDOT as an effective component on the semi-cured layer using the manufactured transparent electrode film, the semi-cured layer was too soft, making it difficult to form the electrode layer.

### COMPARATIVE EXAMPLE 5

Comparative Example 5 was the same as Example 1, with the exception that the degree of curing of the semi-cured layer was 90%.

When forming an electrode layer composed of PEDOT on the surface of the semi-cured layer to fabricate a touch cell using the film as above, poor wettability and 1B adhesion according to ASTM D3359 resulted, and thereby the electrode layer was mostly peeled off.

### EXAMPLE 4

Example 4 was the same as Example 2, with the exception that, upon preparation of a photocurable resin composition for a semi-cured layer, 35 parts by weight of an acrylate resin having an ethylene oxide group based on the total weight of the photocurable resin composition of Example 2 was used. This sample had an X-axis terminal resistance of 254 ohm and a Y-axis terminal resistance of 553 ohm.

The adhesion of the electrode layer of the manufactured touch module was 5B according to ASTM D3359, and thus the electrode layer formed on the semi-cured layer had very good adhesion.

Also, changes in the terminal resistance after aging testing were 5.7% in the upper plate and −3% in the lower plate, and the haze was measured to be 2.1%.

### EXAMPLE 5

Example 5 was the same as Example 4, with the exception that the degree of curing of the semi-cured layer was adjusted to 80%. This sample had an X-axis terminal resistance of 264 ohm and a Y-axis terminal resistance of 554 ohm.

The adhesion of the electrode layer of the manufactured transparent electrode film was 5B according to ASTM D3359, which is evaluated to be very good.

Also, changes in the terminal resistance after aging testing were 7% in the upper plate and −3.4% in the lower plate, and the haze was measured to be 1.87%.

### COMPARATIVE EXAMPLE 6

In Comparative Example 6, a transparent electrode layer containing silver nanowires as an effective component was formed using a commercially available polyester film. This film was subjected to primer treatment to enhance adhesion on both surfaces thereof but did not further include a fully-cured or semi-cured hard coating layer. Also, in this Comparative Example, a coating composition containing silver nanowires as an effective component was prepared by mixing 0.7 g of silver nanowires having a diameter of 80 nm and an average length of about 10 μm with 98.8 g of isopropylalcohol and 0.5 g of a cellulose-based thickener. The silver nanowire coating composition was applied on the 125 μm thick polyester film using a bar coater and dried at about 100° C. for 1 min, thus manufacturing a transparent electrode film having an initial surface resistance of 78 ohm/area and an initial haze of 2.6%.

After reliability treatment for 120 hr under conditions of 85° C. and 85% RH, the film had a surface resistance of 88 ohm/area and a haze of 8.5%.

In this Comparative Example, the properties of the transparent electrode film were evaluated. As is apparent from these results, the silver nanowires were not significant in changes in the surface resistance after reliability testing but were very large in changes in the haze.

### EXAMPLE 6

Example 6 was the same as Comparative Example 6, with the exception that both surfaces of the substrate film were subjected to full-curing and semi-curing hard coating treatment as in Example 2.

The film of Example 6 had an initial surface resistance of 57 ohm/area and a haze of 2.3%. After reliability treatment for 120 hr under conditions of 85° C. and 85% RH, the film had a surface resistance of 55 ohm/area and a haze of 2.8%.

When comparing Example 6 with Comparative Example 6, the transparent electrode film using the film manufactured by the present invention as the substrate material and containing silver nanowires as the effective component had lower changes in the surface resistance even after reliability testing under conditions of 85° C. and 85% RH for 120 hr, and particularly, changes in the haze were much lower.

### COMPARATIVE EXAMPLE 7

In Comparative Example 7, a transparent electrode film was formed using graphene synthesized by chemical vapor deposition (CVD) as a transparent electrode material. While methane (CH₄) gas which is a graphene precursor was allowed to flow into a CVD chamber along with hydrogen (H₂) gas, the chamber in which a copper foil substrate was placed was maintained at about 1,000° C. and then cooled, thereby synthesizing graphene. The synthesized graphene was transferred on a typical polyester film using a known method, ultimately fabricating a graphene transparent electrode film having an initial surface resistance of about 440 ohm/area and an initial haze of 1.3%.

After reliability testing under conditions of 5° C. and 85% RH for 120 hr, this film had a surface resistance of about 1,500 ohm/area and a haze of 2.2%.

As is apparent from the results of this Comparative Example, changes in the surface resistance of the graphene electrode were very significant after reliability testing.

### EXAMPLE 7

Example 7 was the same as Comparative Example 7, with the exception that both surfaces of the substrate film were subjected to full-curing and semi-curing hard coating treatment as in Example 2.

The film of Example 7 had an initial surface resistance of 450 ohm/area and a haze of 1.4%. The film had a surface resistance of 530 ohm/area and a haze of 2.1% after reliability testing for 120 hr of 85° C. and 85% RH.

As for the PET film having no surface treatment or the substrate film surface-treated with a thermoplastic resin through the above comparative examples and examples, when forming the transparent electrode layer containing PEDOT as the effective component, aging under conditions of 85° C./85% RH for 120 hr results in changes in the terminal resistance of the touch cell by 10% or more compared to the initial values and also in very large changes in the haze after aging.

However, a fully-cured photocurable resin layer is formed on one surface of the transparent substrate film such as polyester, a semi-cured photocurable resin layer is formed on the other surface thereof, and the electrode layer containing PEDOT as the effective component is formed on the surface of the semi-cured resin layer, thereby forming a highly reliable transparent electrode film, wherein changes in the surface resistance are less than 10% compared to initial values even after aging testing under conditions of 85° C./85% RH for 120 hr, and also changes in the haze after aging are not significant. Also, the technique of the present invention can be applied to a transparent electrode film containing carbon nanotubes, graphene or silver nanowires as an effective component.

Also, the silver nanowires are a kind of metallic nanowires for imparting conductivity, and thus any kind of metal may be applied so long as it is able to impart electrical conductivity and transmittance.

### INDUSTRIAL APPLICABILITY

According to the present invention, a substrate film for manufacturing a transparent electrode film and a transparent electrode film can be applied to touch screen panels for not only small electronic devices such as smart phones or tablet PCs, but also large display devices such as monitor, TVs, etc.

1. A substrate film for a transparent electrode film, suitable for use in forming a transparent electrode layer of the transparent electrode film, comprising:
a photocurable layer formed on one surface of the substrate film, wherein the photocurable layer is a semi-cured photocurable layer having a degree of photocuring of 45 to 85% so as to enhance adhesion to the transparent electrode layer formed thereon.

2. The substrate film of claim 1, further comprising a photocurable layer formed on the other surface of the substrate film and having a degree of curing of 85% or more.

3. The substrate film of claim 1, wherein the photocurable layer contains an acrylate-based photocurable resin as a hard coating layer material.

4. The substrate film of claim 3, wherein the acrylate-based photocurable resin is an acrylate compound comprising an oxide compound containing alkyl, allyl or phenyl as a structure having one or more carbon atoms, and is used in an amount of 5 to 80 parts by weight based on 100 parts by weight of an acrylate resin.

5. The substrate film of claim 1, wherein the substrate film is a film comprising any one of ester, carbonate, styrene, amide, imide, olefin, sulfone and ether functional groups, a film comprising a polymer prepared by copolymerization of one or more functional groups, a film comprising a polymer blend having one or more functional groups, or a multilayer film formed by laminating polymer films having different functional groups.

6. A method of manufacturing a substrate film for a transparent electrode film, suitable for use in forming a transparent electrode layer of the transparent electrode film, comprising forming a photocurable layer on one surface of the substrate film, wherein the photocurable layer is formed by being cured to a degree of photocuring of 45 to 85% so as to enhance adhesion to the transparent electrode layer formed thereon.

7. A transparent electrode film, comprising:
the substrate film of claim 1; and
a transparent electrode layer formed on a semi-cured photocurable layer of the substrate film.

8. The transparent electrode film of claim 7, wherein the electrode layer is formed using poly(3,4-ethylenedioxythiophene), carbon nanotubes, graphene or metallic nanowires, as an effective component.

9. The transparent electrode film of claim 7, wherein either or both of the semi-cured photocurable layer and the electrode layer further include fine particles to form surface irregularities.

10. The substrate film of claim 2, wherein the photocurable layer contains an acrylate-based photocurable resin as a hard coating layer material.

11. The substrate film of claim 10, wherein the acrylate-based photocurable resin is an acrylate compound comprising an oxide compound containing alkyl, allyl or phenyl as a structure having one or more carbon atoms, and is used in an amount of 5 to 80 parts by weight based on 100 parts by weight of an acrylate resin.

12. The substrate film of claim 2, wherein the substrate film is a film comprising any one of ester, carbonate, styrene, amide, imide, olefin, sulfone and ether functional groups, a film comprising a polymer prepared by copolymerization of one or more functional groups, a film comprising a polymer blend having one or more functional groups, or a multilayer film formed by laminating polymer films having different functional groups.

13. A transparent electrode film, comprising:
the substrate film of claim 2; and
a transparent electrode layer formed on a semi-cured photocurable layer of the substrate film.

14. The transparent electrode film of claim 13, wherein the electrode layer is formed using poly(3,4-ethylenedioxythiophene), carbon nanotubes, graphene or metallic nanowires, as an effective component.

15. The transparent electrode film of claim 13, wherein either or both of the semi-cured photocurable layer and the electrode layer further include fine particles to form surface irregularities.

16. A transparent electrode film, comprising:
the substrate film of claim 3; and
a transparent electrode layer formed on a semi-cured photocurable layer of the substrate film.

17. The transparent electrode film of claim 16, wherein the electrode layer is formed using poly(3,4-ethylenedioxythiophene), carbon nanotubes, graphene or metallic nanowires, as an effective component.

18. The transparent electrode film of claim 16, wherein either or both of the semi-cured photocurable layer and the electrode layer further include fine particles to form surface irregularities.

19. A transparent electrode film, comprising:
the substrate film of claim 4; and
a transparent electrode layer formed on a semi-cured photocurable layer of the substrate film.

20. A transparent electrode film, comprising:
the substrate film of claim 5; and
a transparent electrode layer formed on a semi-cured photocurable layer of the substrate film.
